(19) United States
(12) Patent Application Publication
(10) Pub. No.: US 2009/0205524 A1
(43) Pub. Date: Aug. 20, 2009

(54) AUTOMATIC FEEDER FOR PLANOGRAPHIC PRINTING PLATES

(75) Inventors: Kazuoki Komiyama, Kanagawa (JP); Kikuo Matsuba, Kanagawa (JP); Yoshinori Kawamura, Kanagawa (JP); Toru Itakura, Kanagawa (JP)

Correspondence Address: YOUNG & THOMPSON, 209 Madison Street, Suite 500, ALEXANDRIA, VA, 22314, US

(73) Assignee: FUJIFILM CORPORATION, TOKYO (JP)

(21) Appl. No.: 11/993,974

(22) PCT Filed: Jul. 4, 2006
(86) PCT No.: PCT/JP2006/313256

§ 371 Date: Dec. 27, 2007

(30) Foreign Application Priority Data
Jul. 4, 2005 (JP) 2005-195439

(51) Int. Cl. B41L 47/14

(52) U.S. Cl. 101/477

(57) ABSTRACT

An automatic feeder for planographic printing plates is provided with a storage shelf mounting a plurality of predetermined number of layered and bundled planographic printing plates therein, a conveying unit conveying the planographic printing plate, a sliding friction reducing member, and a separating operation unit for forming a gap between the planographic printing plate positioned at a top in the bundle of the planographic printing plates mounted on the storage shelf, and the planographic printing plate existing therebelow so as to insert the sliding friction reducing member.

### TECHNICAL FIELD

The present invention relates to an automatic feeder for planographic printing plates, the automatic feeding provided with a sheet feeder loaded with bundles of plural planographic printing plates and separating the planographic printing plates one by one so as to feed out.

### BACKGROUND ART

In general, photosensitive printing plates (so-called PS plates), serving as planographic printing plates, are used in offset printing. Further, in the field of the lithographic printing, computer to plate (CTP) systems have been put into practice which receive a fed unexposed photosensitive printing plate, execute a laser exposure process on the basis of digital data of a computer or the like to the photosensitive printing plate, and execute a developing process with an automatic developing machine, which converts a latent image formed on the photosensitive printing plate into a visual image, so as to directly prepare printing plates.

In the photosensitive printing plate used in such a CTP system, a photosensitive layer 14 is configured by applying a layer of a photosensitive agent onto a surface of a thin aluminum base plate 12, as exemplified in FIG. 10. Further, the photosensitive printing plate (the PS plate) 10 includes a surface strengthened type photopolymer PS plate (interleaving-less planographic printing plates) in which a photosensitive agent applied to the aluminum base plate 12 has strength characteristics against external forces (for example, strength characteristics that are twentyfold or greater that of a normal PS plate), protection of interleaving paper is not necessary, and the surface at the recording layer side is reinforced to such a degree that there is no problem with scratches even by being handled in a directly stacked and bundled state.

Further, in such interleaving-less photosensitive printing plates, in order to prevent a desensitizing phenomenon of the photosensitive layer 14 by oxygen, an overcoat layer (a polyvinyl alcohol (PVA)—referred to as an OC layer) 16 is applied onto the outermost surface of the photosensitive layer 14 of the photosensitive printing plate (PS plate). Since the OC layer 16 of the interleaving-less photosensitive printing plate is necessary up until image recording (exposure) is finished but, however, forms an obstacle to development, the OC layer 16 is constructed from a water soluble material in such a manner as to be completely removed by a washing step prior to development.

In such a CTP system using the interleaving-less photosensitive printing plates (the interleaving-less PS plates) as mentioned above, there is provided an automatic feeder of the planographic printing plates. The automatic feeder of planographic printing plates directly brings a back surface of one photosensitive printing plate 10 into contact with the photosensitive surface on a front surface of another photosensitive printing plate 10 so as to form a stack, loads a bundle of a plural predetermined number of layered plates into a housing of the automatic feeder which is light shielded, and, when operation is initiated, separates the photosensitive printing plates 10 one by one from the bundle of photosensitive printing plates with a sheet feeder of the automatic feeder, and feeds the plate out to the exposure processing portion side.

The automatic feeder of the planographic printing plate is constituted by a pickup mechanism for interleaving-less photosensitive printing plates and a PS plate conveying mechanism. In such an automatic feeder for planographic printing plates, since the configuration is that of a sheet feeding unit for interleaving-less planographic printing plates, an interleaving sheet pickup mechanism, an interleaving sheet conveying mechanism and an interleaving sheet accumulating portion are not necessary, and a structure may be that has high productivity, low cost and saves space.

Further, as automatic feeder for planographic printing plates using interleaving-less planographic printing plates a structure may be considered of a so-called roller pick-up type which separates the photosensitive printing plates 10 one by one by bringing a rubber roller into roller contact with the front surface of the photosensitive printing plate 10 at the top of the bundle of plural stacked photosensitive printing plates 10 so as to fed out.

However, in such a roller pick-up type automatic feeder for planographic printing plates in a CTP system using the interleaving-less planographic printing plates mentioned above, since the bundle of the photosensitive printing plates 10 is loaded in the state in which plural photosensitive printing plates 10 are stacked into the housing of the automatic feeder, there is a tendency that the OC layer absorbs some of the water content in the air so as to dissolve and the adhesion thereof is increased, if the inner side of the housing of the automatic feeder reaches a high temperature and humidity (for example, an air temperature of 30° C. and a humidity 50% or higher) such as when operated in the rainy season.

As a result of this, in the roller pick type automatic feeder of the planographic printing plate, as shown in FIG. 11, there is a portion 16A, where the OC layer absorbs water so as to dissolve and the adhesion is increased, that adheres to the back surface of the aluminum base plate 12 of the photosensitive printing plate 10 at the top of the stack, and a feeding load R for separating the photosensitive printing plate 10 at the top from the photosensitive printing plate 10 below so as to feed it out is increased, making it necessary to strongly apply the pickup roller so as to increase the nipping force and increase the feeding force F.

Further, in the roller pick type automatic feeder for planographic printing plates, if the adhesion force of the portion 16A in which the adhesion is increased becomes large, there is a possibility of a state in which plural photosensitive printing plates 10 are fed out together by the pickup roller, and a state in which it is impossible to feed due to such an increase of the feeding load R.

Further, in a roller pick type automatic feeder for planographic printing plates, the pickup roller is strongly applied so as to increase the feeding force F, the portion 16A having the increased adhesion is generally fed out in a state in which the portion 16A is partly or wholly attached to the back surface of the photosensitive printing plate 10 on the top thereof, as shown in FIG. 12, so scratches may be generated on the photosensitive printing plate 10 due to the separation of the OC layer 16.

Accordingly, in such an automatic feeder for planographic printing plate as mentioned above, a unit handling using a suction pad may be considered, for use as the feeder for planographic printing plate so as to prevent damage to the front surface of the photosensitive layer, the OC layer or the like of the planographic printing plate when lifting and feeding out one planographic printing plate from plural stacked planographic printing plates.

In a conventional handing unit utilizing a suction pad, there has been proposed a printing plate feeder which suctions and lifts a front end portion of the top planographic printing plate from plural stacked planographic printing plates accumulated in a cassette, by a suction pad in a suction pad unit.

In such a printing plate feeder, a roller group of a roller support body of a printing plate supporting mechanism is inserted into a gap between the lifted planographic printing plate and the planographic printing plate below so as to support the lower surface of the lifted planographic printing plate in a state in which the planographic printing plates are separated. Further, there is proposed a unit in which in this state, the conveying mechanism moves the suction pad unit upward, conveys the planographic printing plate suctioned and supported by the suction pad to an input aperture of the image processing apparatus and feeds the planographic printing plate into an image processing apparatus (for example, refer to Japanese Patent Application Laid-Open (JP-A) No. 7-172607).

However, in the conventional printing plate feeder mentioned above, since the conveying mechanism operates by moving the suction pad unit upward in a state of suctioning and supporting the planographic printing plate, and by conveying the planographic printing plate to the input aperture of the image processing apparatus, there is a problem that the conveying mechanism becomes complicated, large in size and expensive.

Further, in such a conventional printing plate feeder, since it is necessary to employ a large-sized expensive vacuum pump for maintaining the state of suctioning and supporting the planographic printing plate for a long time from when the suction pad unit suctions and supports one planographic printing plate from the bundle of planographic printing plates until the suction pad finishes conveying the planographic printing plate to the input aperture of the image processing apparatus, there is a problem that the printing plate feeder becomes expensive.

Further, in such a conventional printing plate feeder, since there is a configuration with vacuum hose for connection between the vacuum pump that is fixed and arranged in a predetermined position and the suction pads that are operated so as to move in a long range by the conveying mechanism, the vacuum hose is always moved by a large extent and so is easily deteriorated, therefore it is necessary to carry out frequent maintenance, so that there is the problem of high maintenance costs.

### DISCLOSURE OF THE INVENTION

### Problem to be Solved by the Invention

The present invention is made in the light of the above circumstances, and provides a novel automatic feeder for planographic printing plates in which, when a bundle of plural interleaving-less planographic printing plates are loaded and the planographic printing plates are separated out one by one so as to be fed out by a conveying unit, the recording layer of the front surface of the planographic printing plate that is below the planographic printing plate being fed out may be protected, which has a simple structure, may be inexpensively manufactured, and may be made compact.

### Means for Solving the Problem

In accordance with one aspect of the present invention, there is provided an automatic planographic printing plate feeder including: a storage shelf, mounting a bundle of a predetermined plurality of planographic printing plates, the bundle being formed by stacking the back surface side of a planographic printing plate on a recording surface side that is on the front surface of another planographic printing plate; a conveying unit, conveying out the uppermost planographic printing plate of the bundle of planographic printing plates by applying a force in a conveying direction while pressing the uppermost planographic printing plate; a sliding friction reducing member, interposed in a region in which the pressing load of the conveying unit presses the planographic printing plate below the uppermost planographic printing plate through the uppermost planographic printing plate; and a separating operation unit for inserting the sliding friction reducing member by forming a gap between the uppermost planographic printing plate of the bundle of planographic printing plates mounted on the storage shelf and the planographic printing plate therebelow

In accordance with another aspect of the invention, there is provided an automatic planographic printing plate feeder including: a storage shelf, mounting a bundle of a predetermined plurality of planographic printing plates, the bundle being formed by stacking the back surface side of a planographic printing plate on a recording surface side on the front surface of another planographic printing plate; a conveying unit, conveying out the uppermost planographic printing plate of the bundle of the planographic printing plates by applying a force in a conveying direction while pressing the uppermost planographic printing plate; a sliding friction reducing member, interposed in a region in which the pressing load of the conveying unit presses the planographic printing plate below the uppermost planographic printing plate through the uppermost planographic printing plate; and a separating operation unit for inserting the sliding friction reducing member by forming a gap between the uppermost planographic printing plate of the bundle of planographic printing plates mounted on the storage shelf and the planographic printing plate therebelow, wherein the sliding friction reducing member is formed by an elastic sheet material, a friction coefficient μ1 between the front surface of the sliding friction reducing member and the back surface of the uppermost first planographic printing plate positioned is set smaller than a friction coefficient μ2 between the back surface of the sliding friction reducing member and the front surface of the recording surface side of a second planographic printing plate positioned below the first planographic printing plate, and the separating operation unit serves as a handling unit putting air between the uppermost planographic printing plate and the planographic printing plate therebelow, by lifting and then releasing the uppermost planographic printing plate in the bundle of planographic printing plates mounted in the storage shelf.

Other aspects, features and advantages of the invention will be apparent from the following description made with reference to the accompanying drawings.

### Effect of the Invention

In the automatic feeder of the planographic printing plate of the present invention, since the bundle plural interleaving-less planographic printing plates is loaded, and the planographic printing plates are separated one by one by the conveying unit after interposing the sliding friction reducing member between the planographic printing plate that is conveyed out and the planographic printing plate therebelow, and then conveyed out, there may be obtained an effect that it is possible to protect the recording layer on the front surface of the planographic printing plate that is below the sliding friction reducing member, and such an apparatus has a simple structure, may be inexpensively manufactured, and may be made compact.

### BRIEF DESCRIPTION OF THE DRAWINGS

FIG. 1 is a perspective view showing a whole of a CTP system provided with an automatic feeder of a planographic printing plate in accordance with an exemplary embodiment of the present invention.

FIG. 2 is an outline schematic view of a whole of an inner portion of the CTP system provided with the automatic feeder of the planographic printing plate in accordance with the exemplary embodiment of the invention.

FIG. 3 is an enlarged perspective view showing by picking up a part of a sheet feeder conveying out each of the planographic printing plates from a bundle of the planographic printing plates loaded into the automatic feeder of the planographic printing plate in accordance with the exemplary embodiment of the invention.

FIG. 4 is an enlarged perspective view of a main portion showing by picking up a sucker portion of the sheet feeder conveying out each of the planographic printing plates from the bundle of the planographic printing plates loaded into the automatic feeder of the planographic printing plate in accordance with the exemplary embodiment of the invention.

FIG. 5A is an outline explanatory view of a main portion showing an operation of a sliding contact reducing unit, a conveying-out roller and the sucker which are loaded to the automatic feeder of the planographic printing plate in accordance with the exemplary embodiment of the invention and are interposed between the conveying-out planographic printing plate and the planographic printing plate just therebelow.

FIG. 5B is an outline explanatory view of the main portion showing the operation of the sliding contact reducing unit, the conveying-out roller and the sucker which are loaded to the automatic feeder of the planographic printing plate in accordance with the exemplary embodiment of the invention and are interposed between the conveying-out planographic printing plate and the planographic printing plate just therebelow.

FIG. 5C is an outline explanatory view of the main portion showing the operation of the sliding contact reducing unit, the conveying-out roller and the sucker which are loaded to the automatic feeder of the planographic printing plate in accordance with the exemplary embodiment of the invention and are interposed between the conveying-out planographic printing plate and the planographic printing plate just therebelow.

FIG. 5D is an outline explanatory view of the main portion showing the operation of the sliding contact reducing unit, the conveying-out roller and the sucker which are loaded to the automatic feeder of the planographic printing plate in accordance with the exemplary embodiment of the invention and are interposed between the conveying-out planographic printing plate and the planographic printing plate just therebelow.

FIG. 6A is an outline explanatory view of a main portion showing an operation of a sliding contact reducing unit, a conveying-out roller and a sucker in accordance with the other structure which are loaded to the automatic feeder of the planographic printing plate in accordance with the exemplary embodiment of the invention and are interposed between the conveying-out planographic printing plate and the planographic printing plate just therebelow.

FIG. 6B is an outline explanatory view of the main portion showing the operation of the sliding contact reducing unit, the conveying-out roller and the sucker in accordance with the other structure which are loaded to the automatic feeder of the planographic printing plate in accordance with the exemplary embodiment of the invention and are interposed between the conveying-out planographic printing plate and the planographic printing plate just therebelow

FIG. 6C is an outline explanatory view of the main portion showing the operation of the sliding contact reducing unit, the conveying-out roller and the sucker in accordance with the other structure which are loaded to the automatic feeder of the planographic printing plate in accordance with the exemplary embodiment of the invention and are interposed between the conveying-out planographic printing plate and the planographic printing plate just therebelow.

FIG. 7 is a front elevational view of a main portion at a time when a sliding friction reducing member in the sliding contact reducing unit installed to the automatic feeder of the planographic printing plate in accordance with the exemplary embodiment of the invention is at a standby position.

FIG. 8 is a front elevational view of a main portion at a time when the sliding friction reducing member in the sliding contact reducing unit installed to the automatic feeder of the planographic printing plate in accordance with the exemplary embodiment of the invention is at a used position.

FIG. 9 is an enlarged perspective view of a main portion showing by picking up a part of a sheet feeder provided with a sliding contact reducing unit in accordance with the other structure installed to the automatic feeder of the planographic printing plate in accordance with the exemplary embodiment of the invention.

FIG. 10 is an outline explanatory view of a main portion exemplifying a layered state of the planographic printing plates in a bundle of interleaving-less planographic printing plates.

FIG. 11 is an outline explanatory view of a main portion exemplifying the layered state of the planographic printing plates in the bundle of interleaving-less planographic printing plates, at a time when an OC layer of the planographic printing plate absorbs water so as to be adhered.

FIG. 12 is an outline explanatory view of a main portion exemplifying a state in which the OC layer of the planographic printing plate absorbs water in the planographic printing plates in the bundle of interleaving-less planographic printing plates, and is adhered to a back surface of the conveyed-out planographic printing plate so as to be peeled off.

### BEST MODE FOR CARRYING OUT THE INVENTION

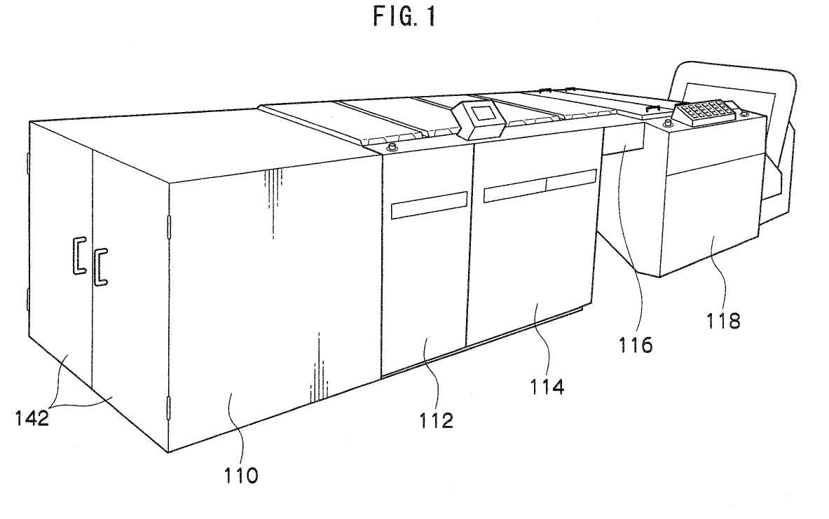

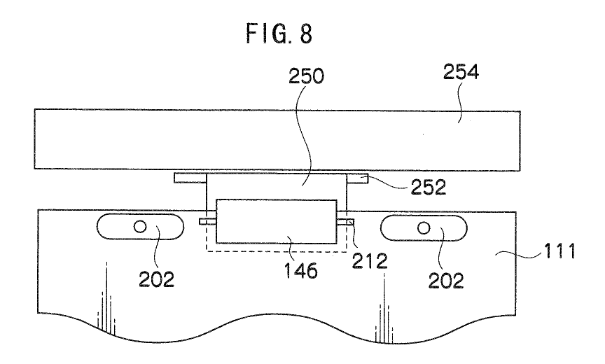

A description will be given of an exemplary embodiment relating to an automatic feeder of a planographic printing plate in accordance with the present invention with reference to FIGS. 1 to 9. The automatic feeder of the planographic printing plate in accordance with the present exemplary embodiment is structured, for example, such as to load a bundle of a plurality of predetermined number of so-called interleaving-less photosensitive printing plates (interleaving-less PS plates) corresponding to photopolymer PS plates which have a photosensitive surface formed by applying a photosensitive agent to a front surface of the photosensitive printing plate and being strong (equal to or more then twentyfold) against an external force, and do not require a protection of the inserting paper, in comparison with general photosensitive printing plates (PS plates) which are available at present, and may execute a feeding work of separating the photosensitive printing plate corresponding to each of the planographic printing plates one by one by a sheet feeder so as to feed out.

In other words, the interleaving-less planographic printing plate (the interleaving-less photosensitive printing plate) used in the automatic feeder of the planographic printing plate is provided with a photosensitive surface formed by applying a photosensitive surface (a photosensitive agent surface corresponding to an image recording layer) including a photosensitive material on a support body corresponding to a thin aluminum plate formed as a rectangular plate shape having a predetermined size.

The interleaving-less photosensitive printing plate used in the automatic feeder of the planographic printing plate has a characteristic that a scratch, a pressure protective covering or the like is not generated even by transporting or storing in a stacked state and bundling a plural predetermined number of photosensitive printing plates after manufacturing and abolishing the inserting paper, in a state of directly bringing the photosensitive surface (a back surface corresponding to the PS plate aluminum surface) corresponding to the back surface of the photosensitive printing plate into contact with the photosensitive surface (an Em surface corresponding to the photosensitive agent surface) corresponding to the front surface of the photosensitive printing plate, and further separating and conveying out the photosensitive printing plate one by one while scuffing the photosensitive surface by the aluminum surface corresponding to a base material of the photosensitive printing plate.

Further, the interleaving-less photosensitive printing plate used in the automatic feeder of the planographic printing plate may be structured such that the back surface corresponding to the aluminum material surface corresponding to the back surface of the photosensitive printing plate is coated with an overcoat layer for preventing a scuff scratch from being formed on the recording surface of the front surface of the photosensitive printing plate layered below the back surface.

The interleaving-less photosensitive printing plates are layered at a predetermined number without any interleaving sheet after being manufactured so as to be bundled as a rectangular parallelepiped and packed, and are set in a state in which handling such as conveying and storage are easily executed. The interleaving-less photosensitive printing plates are fed in a light shielded state to an inner portion of the automatic feeder of the planographic printing plate provided in the CTP system, in a state of being layered at the predetermined number without any interleaving sheet after being unpacked.

The computer to plate (CTP) system executes a laser exposure process on the basis of a digital data of a computer or the like, and executes a developing process converting a latent image formed on the photosensitive printing plate into a visual image by an automatic developing machine so as to directly manufacture the printing plate.

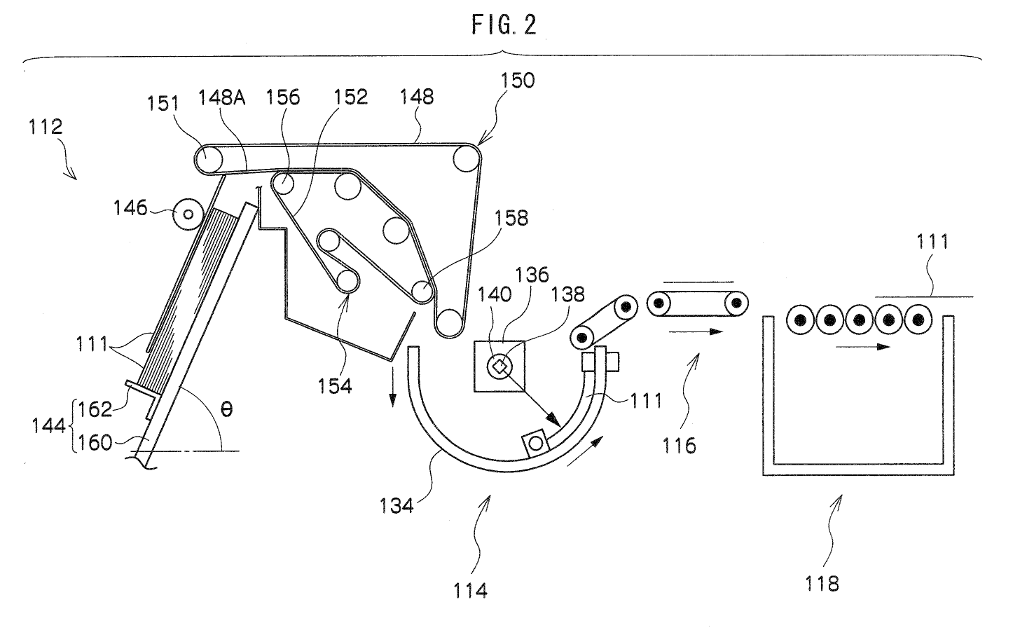

As shown in FIGS. 1 and 2, the CTP system is provided with an automatic feeder 110 to which a bundle of a plurality of predetermined number of layered planographic printing plates 111 without any interleaving sheet is fed, a sheet feeder 112 which continuously separates and feeds the planographic printing plate 111 (PS plate) one by one from the bundle of the planographic printing plates 111 to the automatic feeder 110, an inner drum exposure apparatus (a monogon scanner) 114, a buffer apparatus 116 and a developing process apparatus 118.

The automatic feeder 110 in the CTP system is structured such as to be connected with the sheet feeder 112 in an inner portion. In order to structure the sheet feeder 112, a storage shelf 144 is installed in an inner portion of a door 142 of the automatic feeder 110. The storage shelf 144 is structured by installing a shelf member 162 to a support table 160 arranged diagonally at a predetermined angle θ from a floor surface of the automatic feeder 110 to an upper portion of the inner drum exposure apparatus 114 side in such a manner as to be capable of regulating a height position. In this storage shelf 144, the support table 160 is inclined at a range between 60 degree and 80 degree, preferably at 70 degree with respect to a horizontal plane.

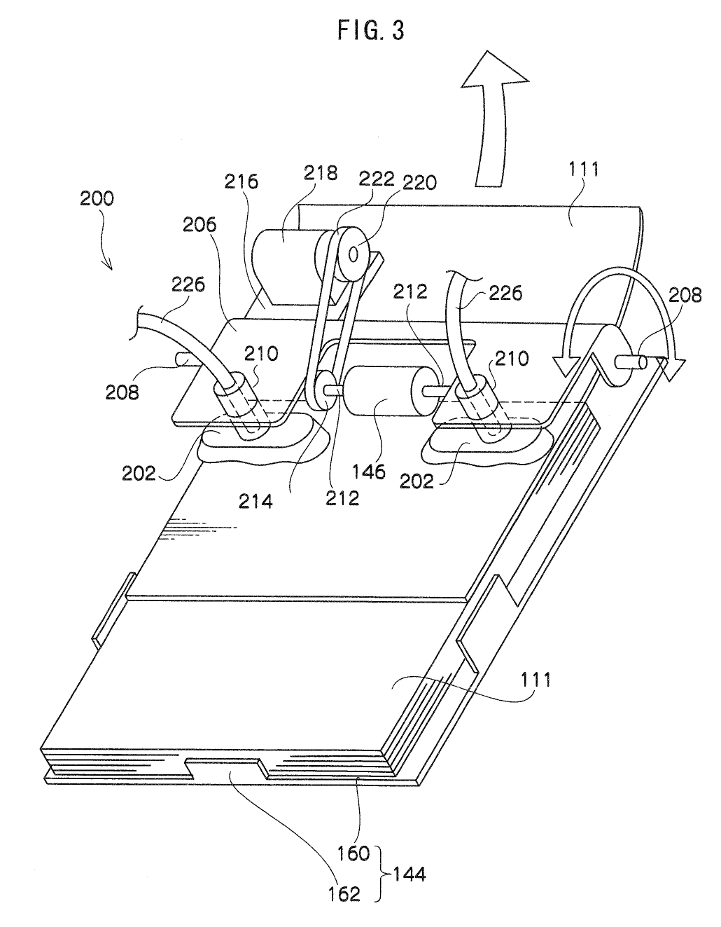

In order to mount the bundle of the planographic printing plates 111 layered at the predetermined number without any interleaving sheet in the storage shelf 144 structured as mentioned above, an upstream side end portion in a conveying direction of the bundle is mounted to the shelf member 162 so as to be mounted in such a manner as to be diagonally reclined to the front surface of the support table 160, as shown in FIGS. 2 and 3.

In accordance with the structure mentioned above, in the bundle of the planographic printing plates 111 layered at the predetermined number without any interleaving sheet mounted on the support table 160 arranged diagonally at the predetermined angle, the planographic printing plate 111 positioned closest to the front surface may reduce a force pressuring contacting the planographic printing plate 111 existing therebelow on the basis of its own weight in comparison with the case that the storage shelf 144 is arranged horizontally.

Further, in the case of being structure as mentioned above, it is possible to reduce a magnitude in a horizontal direction of the automatic feeder 110 in comparison with the case that the storage shelf 144 is arranged horizontally so as to intend to downsize the apparatus.

Further, in the sheet feeder 112, there are arranged at a position in an upper side of the storage shelf 144 a handling unit handling the planographic printing plate 111 existing a top position in a plurality of interleaving-less planographic printing plates 111 and conveyed-out so as to reduce an adhesion force with the adjacent planographic printing plate 111, and forming a gap between the planographic printing plate 111 in the top portion and the planographic printing plate 111 just therebelow so as to interpose the sliding contact reducing unit at a nip corresponding position of the conveying-out roller, and conveying-out unit structured as a roller pick type or the like corresponding to a conveying unit conveying out the planographic printing plate 111 by applying a force in a conveying direction while pressing the planographic printing plate 111 in the top portion of the layered planographic printing plates 111 layered for separating and conveying out the handled planographic printing plate 111 one by one.

In this case, “handling” means lifting the conveyed-out planographic printing plate 111 existing at the top position in the bundle (the stack plates) of a plurality of interleaving-less planographic printing plates 111 and putting an air between the planographic printing plate 111 and the planographic printing plate 111 therebelow.

Further, in the sheet feeder 112, the structure may be made such as to be provided with a separating operation unit for forming the gap between the planographic printing plate 111 in the top portion and the planographic printing plate 111 just therebelow so as to interpose the sliding contact reducing unit at the nip corresponding position of the conveying-out roller, in addition to the handling unit.

Further, in the sheet feeder 112, in order to simplify the structure for executing the handling motion so as to inexpensively manufacture, it is important to put the air in a wider range by making a lifting amount of the planographic printing plate 111 as small as possible at a time of the handling motion, and increasing an amount of the air put between the conveyed-out planographic printing plate 111 existing at the top position and the planographic printing plate 111 existing therebelow.

As shown in FIG. 3, in the sheet feeder 112, there is arranged a pickup unit 200 integrally structured by installing the handling unit and the roller pick type conveying-out unit on a single operating member 206. In this pickup unit 200, a sucker (a vacuum sucker) 202 serving as the handling unit, and a rubber roller conveying-out roller 146 serving as the roller pick type conveying-out unit are installed to the operating member 206.

The operating member 206 is formed as a predetermined deformed plate shape in which a center portion of a long plate is notched in a U-shaped form, and is provided with a rotating shaft rod 208 from both end portions in a longitudinal direction. The operating member 206 is structured such as to be wholly controllable at a predetermined angle so as to rotate around the rotating shaft rod 208 by connecting the rotating shaft rod 208 protruding from both end portions to a rotating operation machine driven and controlled by a control apparatus (not shown) in a state in which a longitudinal direction thereof is directed to a direction orthogonal to the conveying direction.

The suckers 202 are installed to both end portions in the longitudinal direction of the operating member 206 via elevating apparatuses 210, in a so-called swingable state. The elevating apparatus 210 is structured such as to be capable of elevating the sucker 202 from an suctioning position closely attaching to the front surface of the planographic printing plate 111 to a handling operation position lifting so as to be spaced at a predetermined distance, by utilizing an actuator or the like drive controlled by the control apparatus.

The sucker 202 is structured as a suction cup apparatus for a vacuum adhesion, as shown in FIG. 4, and a suction cup portion for the vacuum adhesion is formed in an oval shape. The sucker 202 is structured such that a skirt portion 202A brought into contact with the planographic printing plate 111 is formed as a comparatively small wavy shape. In the case that the skirt portion 202A is formed as the comparatively wavy shape, the planographic printing plate 111 is elastically deformed so as to be along the wavy shape of the skirt portion 202A at a time of suctioning the skirt portion 202A to the front surface of the planographic printing plate 111. Accordingly, it is possible to easily inflow the air from the gap between the suctioned planographic printing plate 111 and the planographic printing plate 111 existing therebelow so as to suitable execute the handling motion for canceling the vacuum close attachment.

Further, a suction port portion 224 for sucking the air is open to an inner center portion brought into contact with the planographic printing plate 111 of the skirt portion 202A of the sucker 202. One end portion of a vacuum hose 226 is connected to the suction port portion 224. Further, the other end portion of the vacuum hose 226 is connected to a vacuum pump (not shown), and the structure is made such that the skirt portion 202A is adhered to the front surface of the planographic printing plate 111 by drive controlling the vacuum pump by the control apparatus so as to suck the air from the suction port portion 224 of the skirt portion 202A of the sucker 202 via the vacuum hose 226.

In this case, since the sucker 202 executes the handling motion of lifting the planographic printing plate 111 positioned at the top in the bundle of the planographic printing plates 111 mounted to the storage shelf 144 from the storage shelf 144 and thereafter separating, one driving time of the vacuum pump is short, and the suction capacity of the air is small and good. Accordingly, it is possible to utilize an inexpensive vacuum pump which is comparatively compact and has a low output.

As shown in FIG. 3, a conveying-out roller 146 is arranged in the operating member 206 in such a manner as to face to an inner side of the U-shaped notch portion provided in the center portion in the longitudinal direction. The conveying-out roller 146 is installed in such a manner that both end portions of a rotating shaft 212 are rotatably supported to bearing members (not shown) provided in a protruding manner on a back surface of the operating member 206.

In order to rotationally drive the conveying-out roller 146, a pulley 214 is coaxially fixed to the rotating shaft 212 protruding from one end portion of the conveying-out roller 146. Further, a driving motor 218 drive controlled by the control apparatus is installed in a pedestal 216 provided in a protruding manner in a part of the operating member 206. A driving pulley 220 is coaxially fixed to an output shaft of the driving motor 218.

An endless belt 222 for a winding and driving mechanism is wound between the driving pulley 220 of the driving motor 218, and the pulley 214 of the conveying-out roller 146, and the conveying-out roller 146 is structured such as to be rotationally drivable by the driving motor 218.

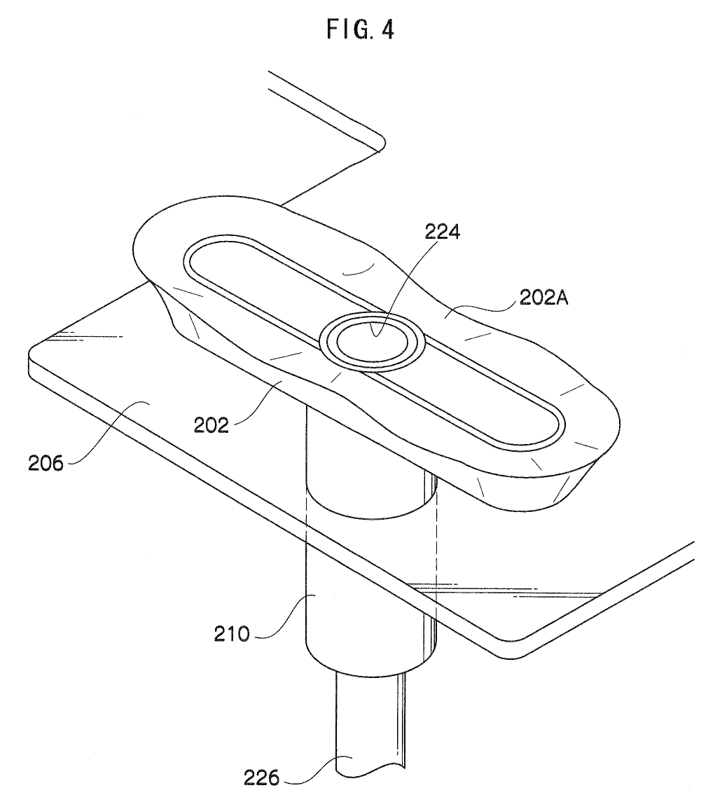

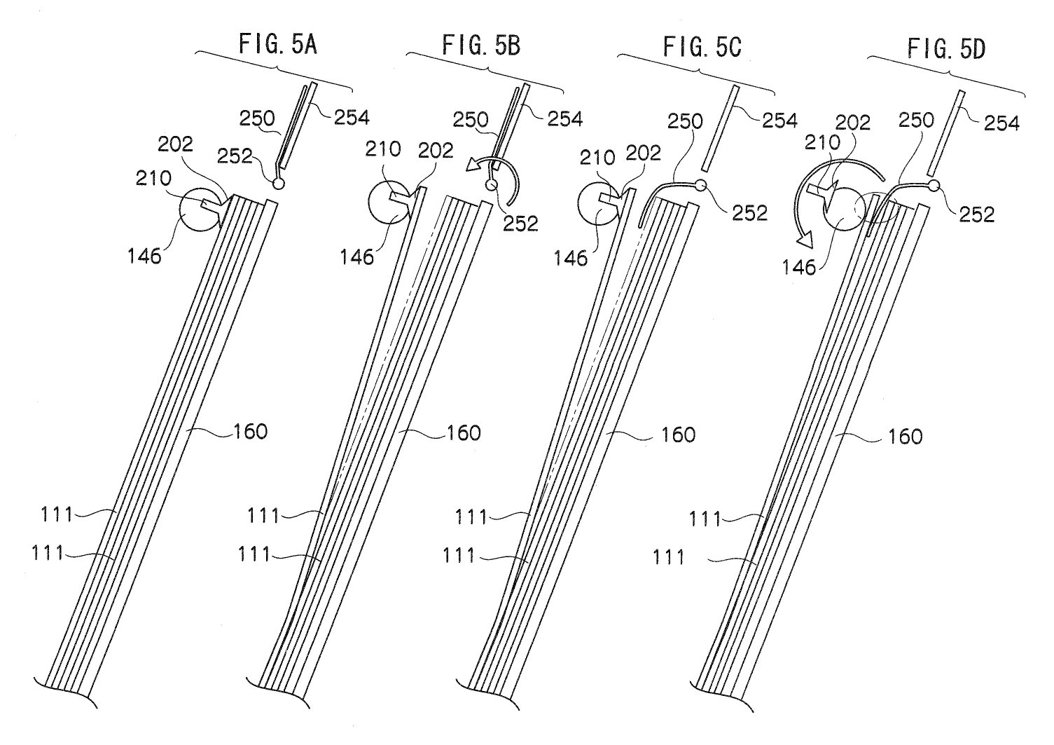

As shown in FIGS. 5A to 8, in the sheet feeder 112, the sliding contact reducing unit is arranged at a predetermined position brought into contact with the back side of the bundle of the planographic printing plates 111, in the downstream side end portion in the conveying direction in the bundle of the planographic printing plates 111 mounted in the storage shelf 144.

The sliding contact reducing unit is structured such as to be put between the first planographic printing plate 111 positioned closest to the front surface side and the second planographic printing plate 111 layered just therebelow, at a time of executing the motion of conveying out in the state of receiving the first planographic printing plate 111 conveyed-out from the bundle of the layered planographic printing plates 111 by the recording surface on the front surface of the second planographic printing plate 111 just therebelow, and prevent scratches from being formed on the recording layer of the second planographic printing plate 111 due to friction during conveying between the first planographic printing plate 111 and the second planographic printing plate 111 therebelow.

in the sliding contact reducing unit shown in FIGS. 5 to 8, there is employed a sliding friction reducing member 250 corresponding to an insertion member which is made of a synthetic resin material or the like being thin and rich in elasticity and having an abrasion resistance to form a flexible sheet.

The sliding friction reducing member 250 is formed in such a size and a shape as to correspond to a peripheral range portion (a range in which the load by the conveying-out roller 146 of the roller pickup mechanism is applied to the Em surface of the second planographic printing plate 111, that is, a range in which the load pressing by the conveying-out roller 146 corresponding to the conveying unit presses the planographic printing plate 111 below the planographic printing plate 111 at the top position through the planographic printing plate 111 at the top position) in which such a predetermined nip force as to scratch the recording surface (Em surface) is applied to the second planographic printing plate 111 just below the first planographic printing plate 111 at the top position, at a time of pressure contacting the conveying-out roller 146 onto the first planographic printing plate 111 existing at the position closest to the front surface of the bundle of the planographic printing plates 111.

Further, the sliding friction reducing member 250 is structured such as to make a friction coefficient μ1 between the front surface of the sliding friction reducing member 250 and the back surface of the first planographic printing plate 111 existing at the position closest to the front surface of the bundle of the planographic printing plates 111 smaller than a friction coefficient μ2 between the back surface of the sliding friction reducing member 250 and the recording surface corresponding to the front surface of the second planographic printing plate 111 positioned below the first planographic printing plate 11.

In accordance with the structure as mentioned above, when the conveying-out roller 146 comes into roller contact with the front surface of the first planographic printing plate 111 with a predetermined nip force so as to execute the conveying-out motion, a friction resistance between the front surface side of the sliding friction reducing member 250 and the first planographic printing plate 111 coming into sliding contact therewith becomes smaller than the friction resistance between the back side of the sliding friction reducing member 250 and the second planographic printing plate 111 brought into contact therewith. Accordingly, it is possible to prevent the sliding friction reducing member 250 from being pulled out to the downstream side in the conveying direction together with the conveying-out motion of the first planographic printing plate 111.

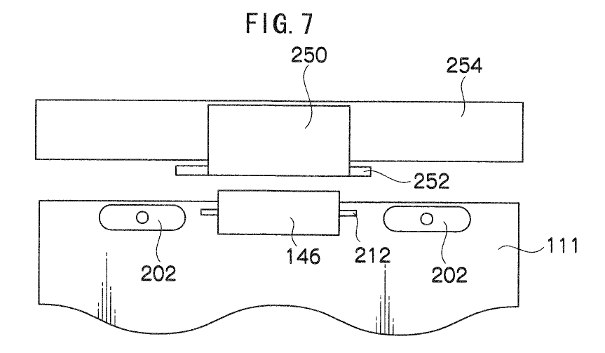

n the sliding friction reducing member 250 structured as mentioned above, a shaft member 252 is integrally installed to one end line portion thereof. The rotating shaft member 252 is formed such that both end portions of the shaft member 252 protrude respectively from both ends of the sliding friction reducing member, and is supported and received in such a manner as to be movable between a standby position which is along the conveying-out guide member 252 of the planographic printing plate 111 arranged on a conveying path coming next to the storage shelf 144, as shown in FIGS. 5A and 7, and a used position which is held between the first planographic printing plate 111 existing at the position closest to the front surface side of the bundle of the planographic printing plates 111 shown in FIGS. 5C, 5D, 6B, 6C and 8 and the second planographic printing plate 111 positioned just therebelow, by axially attaching each of the protruding end portions by a bearing (not shown).

Further, in the sliding contact reducing unit shown in FIG. 5, the rotating shaft member 252 is structured such as to be selectively operable to move the sliding friction reducing member 250 to the standby position and the used position, by being rotationally operated by a driving operation unit such as an actuator, and a motor controlled by a control apparatus (not shown).

Further, in the sliding contact reducing unit, in place of operating so as to move the sliding friction reducing member 250 by the driving operation unit, the structure may be made such that the sliding contact reducing unit is automatically set to the used position under action of gravity.

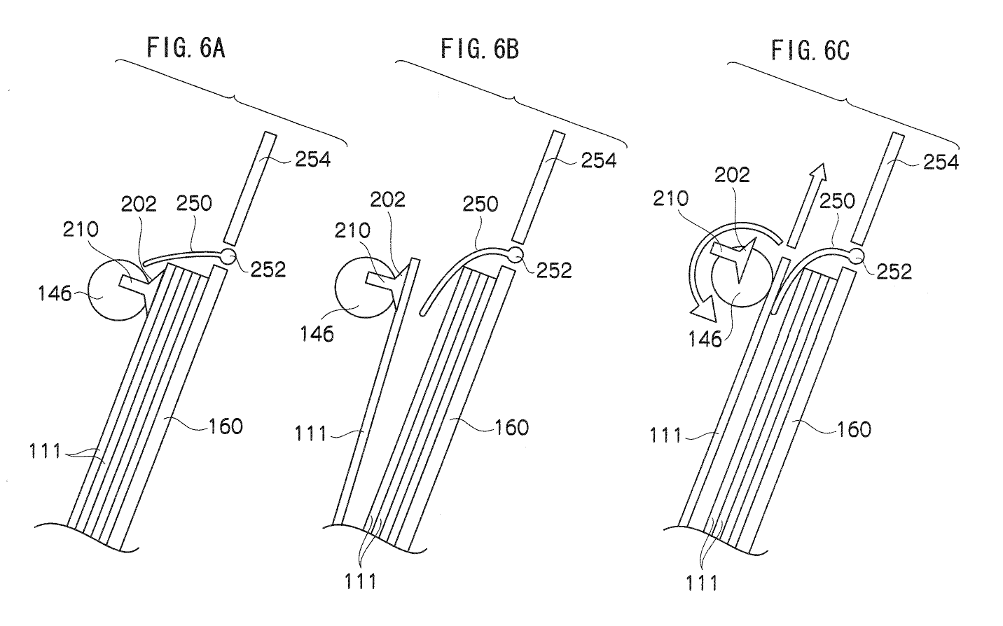

In this case, as shown in FIGS. 6 to 6C, the rotating shaft member 252 axially attaching the sliding friction reducing member 250 is supported and received rotatably by a bearing member (not shown), and the structure is made such that a free end portion of the sliding friction reducing member 250 comes to a state in which it faces so as to cover a leading end side of the first planographic printing plate 111 existing at the position closest to the front surface of the bundle of the planographic printing plates 111 due to its own weight as shown in FIG. 6A.

In the case of being structured as shown in FIGS. 6 to 6C, when the first planographic printing plate 111 existing at the position closest to the front surface of the bundle of the planographic printing plates 111 is lifted to the handling operation position by the sucker 202 in such a manner as to be spaced at a predetermined distance from the front surface of the second planographic printing plate 111, the free end portion of the sliding friction reducing member 250 comes off from the leading end of the lifted first planographic printing plate 111, and drops due to its own weight so as to be automatically changeable to the set state of being covered on the front surface of the second planographic printing plate 111, as shown in FIG. 6B.

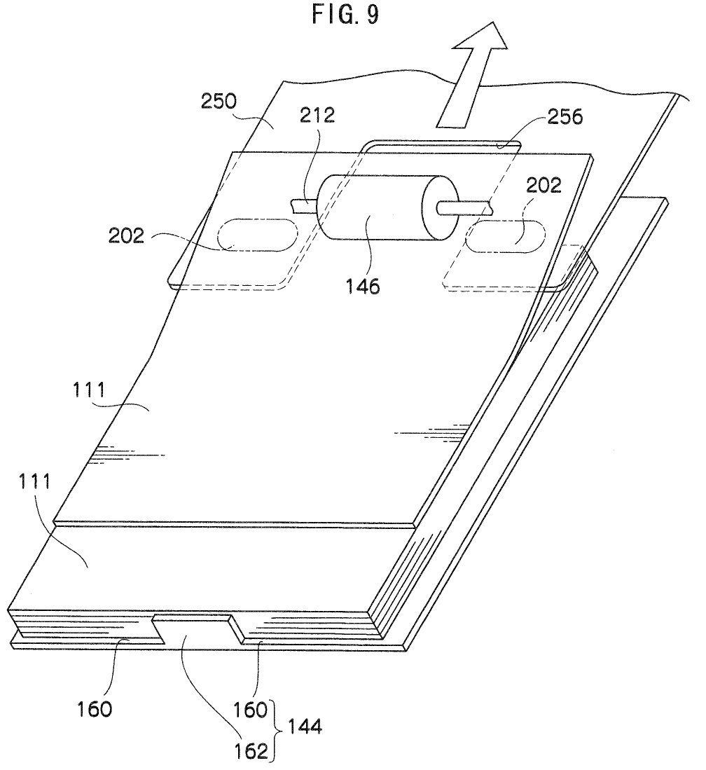

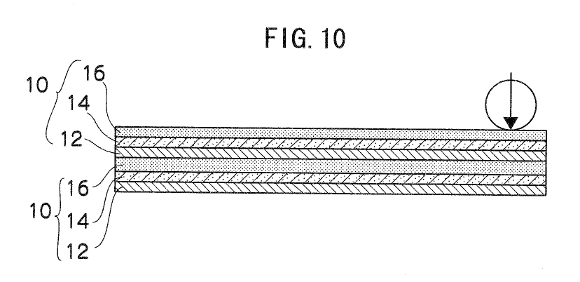

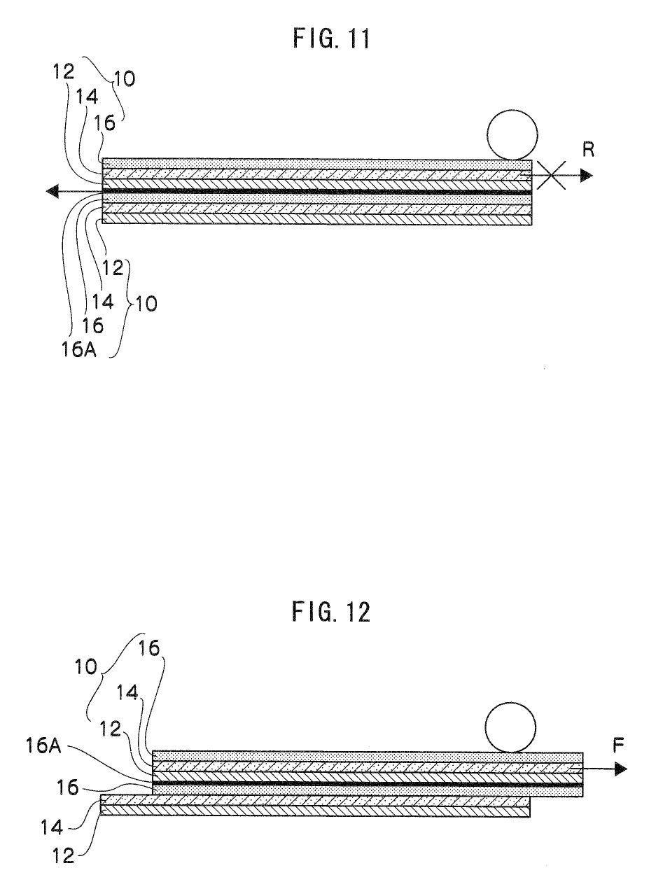

Further, the sliding friction reducing member 250 may be structured as shown in FIG. 9. In the structure shown in FIG. 9, the sliding friction reducing member 250 is provided with a buffering member 256 by notching a predetermined range corresponding to the conveying-out roller 146 of the flexible flat plate member having a width equal to more a horizontal width (a width in a direction orthogonal to the conveying direction) of the planographic printing plate 111.

The sliding friction reducing member 250 provided with the buffering portion 256 sets a portion of the first planographic printing plate 111 corresponding to the range of the buffering portion 256 in a floating state at a thickness of the sliding friction reducing member 250, at a time of being set to the used position at which the free end portion is held between the first planographic printing plate 111 existing at the position closest to the front surface of the bundle of the planographic printing plates 111 and the second planographic printing plate 111 positioned just therebelow.

In this state, in the case that the conveying-out roller 146 is brought into pressure contact with the portion corresponding to the range of the buffering portion 256 of the first planographic printing plate 111, the portion in the range of the buffering portion 256 in the first planographic printing plate 111 is elastically deformed, and comes into pressure contact with the recording surface corresponding to the front surface of the second planographic printing plate 111 just therebelow.

Accordingly, the nip force which the conveying-out roller 146 applies to the recording surface of the second planographic printing plate 111 via the first planographic printing plate 111 and the buffering portion 256 is lightened at a reaction force at a time when the first planographic printing plate 111 is elastically deformed.

Accordingly, the portion in the range of the buffering portion 256 in the first planographic printing plate 111 is elastically deformed so as to reduce the strength slidably contacting with the recording surface of the front surface of the second planographic printing plate 111, at a time of executing the motion of bringing the conveying-out roller 146 into roller contact with the first planographic printing plate 111 by the predetermined nip force, whereby it is possible to prevent the scratch from being formed on the recording surface of the second planographic printing plate 111.

A degree of the operation for reducing the strength at which the back surface of the first planographic printing plate 111 is slidably contacted with the recording surface of the second planographic printing plate 111 by the buffering portion 256 of the sliding friction reducing member 250 may be regulated by changing the thickness of the sliding friction reducing member 250.

In this case, in the sliding friction reducing member 250 shown in FIG. 9 mentioned above, the description is given of the structure in which the buffering portion 256 is formed by notching a part of the sliding friction reducing member 250, however, the buffering portion 256 may be structured such that a thickness of the predetermined range corresponding to the conveying-out roller 146 in the sliding friction reducing member 250 becomes thinner at a predetermined amount than a thickness of the other portions.

Next, a description will be given of a motion of handling the conveyed-out planographic printing plate 111 existing at the top position in the bundle of a plurality of interleaving-less planographic printing plates 111, and a conveying-out motion of separating and conveying out the handled planographic printing plate 111 one by one, by utilizing the pickup unit 200 having the structure shown in FIG. 3 and the sliding contact reducing unit explained in FIGS. 5 to 9.

The pickup unit 200 is operated so as to be moved among a pickup position, a handling operation position capable of inserting the sliding contact reducing unit, and an evacuation position, by a rotary operating machine (not shown).

The evacuation position of the pickup unit 200 is set to such a position that the conveying-out 146 and the sucker 202 are spaced at a predetermined distance from the bundle of a plurality of interleaving-less planographic printing plates 111 and do not form an obstacle to the motion of resupplying the bundle of a plurality of interleaving-less planographic printing plates 111 to the storage shelf 144.

The pickup unit 200 stands by at the standby position in a state in which the sucker 202 is moved at a predetermined ascent position which is spaced from the contact level of the conveying-out roller 146 with the planographic printing plate 111 by controlling so as to drive the elevating apparatus 210 by the control apparatus.

The pickup unit 200 is moved to the upper surface of the bundle of the interleaving-less planographic printing plate 111 by the rotation operating machine controlled so as to be driven by the control apparatus (not shown), from the state of standing by at the evacuation position, for executing the handling motion at a time of starting the conveying-out motion of the planographic printing plate 111.

At a time of this motion, the control apparatus controlling so as to drive the pickup unit 200 controls so as to drive the elevating apparatus 210, thereby bringing the conveying-out roller 146 into contact with the front surface of the first planographic printing plate 111 positioned at the top and setting the sucker 202 in the state of being in pressure contact with the front surface of the planographic printing plate 111, as shown in FIGS. 5A and 6A.

Next, the control apparatus suctions the skirt portion 202A to the front surface close to the end portion in the leading end side in the conveying direction of the planographic printing plate 111, by sucking the air from the suction port portion 224 of the skirt portion 202A of the sucker 202 via the vacuum hose by driving the vacuum pump. On the basis of the motion, since the portion close to the end portion in the leading end side in the conveying direction of the planographic printing plate 111 is elastically deformed along the wavy shape of the skirt portion 202A, a comparatively small opening to which the air may inflow is formed with respect to the front surface of the planographic printing plate 111 existing therebelow, and there is generated such a state that the close contact is partly canceled.

Next, the control apparatus controls so as to drive the elevating apparatus 210, thereby setting the sucker 202 to a state shown in FIG. 5B in which the sucker 202 is moved to a predetermined ascent position which is spaced from the contact level of the conveying-out roller 146 with the planographic printing plate 111. In this state, the portion near the end portion in the leading end side in the conveying direction of the planographic printing plate 111 forms a comparatively small opening along the wavy shape of the skirt portion 202A, and the portion near the end portion in the leading end side in the conveying direction of the planographic printing plate 111 is brought into contact with the conveying-out roller 146 in the center portion thereof, and is lifter up by the sucker 202 in both side portions thereof so as to be elastically deformed in such a manner as to draw a comparatively large wave and come to a curved state, whereby there is generated a state in which the close attachment is wholly cancelled over the while in the width direction of the leading end in the conveying direction between the conveyed-out planographic printing plate 111 and the planographic printing plate 111 existing therebelow.

Further, since the planographic printing plate 111 conveyed-out at a time of the motion of moving the pickup unit 200 to the handling operation position is spaced in the elastically deformed state in which the leading end portion forms the comparatively small wavy shape and the comparatively large wavy shape, the planographic printing plate 111 is peeled off in a state in which a large quantity of air may easily inflow from the gap which is spaced over a whole width from the front surface of the planographic printing plate 111 existing therebelow, whereby the air rapidly inflows toward the rear end side in the conveying direction of the conveyed-out planographic printing plate 111 and the spaced range is widened.

Since the sucker 202 is installed so as to be swingable at a time of this motion, it is possible to prevent the unreasonable bending force from being applied to the planographic printing plate 111.

Further, in this sheet feeder 112, the sliding friction reducing member 250 is operated so as to be moved from the standby position to the used position by rotationally operating the rotating shaft member 252 by the driving operation unit controlled by the control apparatus (not shown). In this case, in the structure in accordance with the sliding friction reducing member 250 shown in FIGS. 6A to 6C, it is automatically set to the used position on the basis of its own weight of the sliding friction reducing member 250.

Next, the control apparatus stops a vacuum pump (not shown) so as to release the attracting force of the sucker 202 with respect to the planographic printing plate 111. Accordingly, in the planographic printing plate 111 diagonally rested against the storage shelf 144, the leading end portion in the conveying direction executes a falling motion onto the front surface side of the planographic printing plate 111 existing therebelow on the basis of an elastic return force and its own weight. At a time of this falling motion, since the air existing between the conveyed-out planographic printing plate 111 and the planographic printing plate 111 existing therebelow is pushed out toward the upstream side in the conveying direction from the downstream side in the conveying direction, the air flows between the upstream side portion in the conveying direction in the conveyed-out planographic printing plate 111 and the front surface of the planographic printing plate 111 therebelow, thereby setting both the elements to the state in which both the elements are wholly separated and adjacent via the air layer, that is, the state in which both the elements are adjacent by reducing the adhesion force.

In this case, the handling motion as mentioned above may be executed plural times or may be accompanied by a swinging motion and an inciting motion.

Further, the handling motion by the pickup unit 200 as mentioned above is arranged such that the bundle of the planographic printing plates 111 layered at the plural numbers without any interleaving sheet is mounted on the support table 160 arranged diagonally at a predetermined angle, whereby an improved effect may be obtained.

Next, the control apparatus controls so as to drive the elevating apparatus 210, and moves the sucker 202 to a predetermined ascent position which is spaced from the contact level of the conveying-out roller 146 with the planographic printing plate 111. Further, the control apparatus controls so as to drive the rotating operation machine (not shown), and sets the pickup unit 200 to a state shown in FIG. 5D in which the pickup unit 200 is moved to the pickup position.

Thereafter, the control apparatus controls so as to drive the driving motor 218 and rotationally drives the conveying-out roller 146 so as to roll in a state of being pressure contact with the front surface of the planographic printing plate 111, thereby applying a desired nip force and conveying out the planographic printing plate 111 toward the conveying belt winding mechanism.

At this time, since the conveyed-out planographic printing plate 111 is handled, whereby the adhesion force is reduced and the conveying load is reduced, the conveying force necessary for the conveying-out roller 146 to feed out the planographic printing plate 111 is reduced. Accordingly, it is possible to reduce the nip force of the conveying-out roller 146.

In the sheet feeder 112, it is possible to prevent the back surface of the first planographic printing plate 111 from coming into sliding contact with the recording surface on the front surface of the second planographic printing plate 111 so as to scratch, on the basis of the operation of the sliding friction reducing member 250 interposed between the conveyed-out first planographic printing plate 111 and the second planographic printing plate 111 therebelow.

In other words, it is possible to reduce the conveying load by canceling the vacuum close attachment between the planographic printing plate 111 roller contacted by the conveying-out roller 146 so as to be conveyed-out and the planographic printing plate 111 just therebelow, it is possible to reduce an increase of the conveying load even if the friction coefficients of the overcoat layer 16 and the photosensitive layer 14 at a time when the ambient atmosphere surrounding the apparatus has high temperature and humidity are increased, it is possible to reduce an increase of the nip load of the conveying-out roller 146 in correspondence to the increase of the conveying load, it is possible to make the conveyed-out first planographic printing plate 111 sliding friction with the front surface of the sliding friction reducing member 250 in the range in which the nip force of the conveying-out roller 146 is applied, and it is possible to protect the recording layer on the front surface of the second planographic printing plate 111.

Next, if the conveying-out motion of one planographic printing plate 111 mentioned above is finished, the control apparatus controls so as to drive the rotating operation machine (not shown), and returns the pickup unit 200 to the evacuation position so as to get ready for the next conveying motion.

In this case, in the structure example of the pickup unit 200 mentioned above, the structure is made, as shown in FIG. 3, such that the control apparatus controls so as to drive the elevating apparatus 210 and moves up and down the sucker 202, however, the structure may be made such that the conveying-out roller 146 and the sucker 202 execute a desired motion via a mechanical interlocking operation mechanism utilizing a link mechanism (not shown).

In the sheet feeder 112 structured as mentioned above, the conveying-out roller 146 is brought into roller contact with the planographic printing plate 111 existing in the top of the bundle of the planographic printing plates 111 mounted in the storage shelf 144, and only one planographic printing plate 111 which is separated so as to be conveyed-out is fed to the conveying belt winding mechanism.

As shown in FIG. 2, in order to convey each of the planographic printing plates 111 from the storage shelf 144 to the inner drum exposure apparatus 114, in the conveying belt winding mechanism, there are installed a main conveying belt winding mechanism 150 in which a main conveying belt 148 is provided in a tensional manner, and an auxiliary conveying belt winding mechanism 154 in which an auxiliary conveying belt 152 is provided in a tensional manner.

The main conveying belt winding mechanism 150 is provided in a tensional manner with the conveying belt 148 between a conveying-in position of the planographic printing plate 111 corresponding to the upper portion of the storage shelf 144 and a conveying-out position to the inner drum exposure apparatus 114.

Further, the auxiliary conveying belt winding mechanism 154 is structured such as to use a part of the conveying path set in a lower side of the main conveying belt 148 in the main conveying belt winding mechanism 150 in common so as to prevent the planographic printing plate 111 during conveying from falling away.

Accordingly, the auxiliary conveying belt winding mechanism 154 is structured such that the main conveying belt 148 and the auxiliary conveying belt 152 travel along a section from an intermediate roller 156 in a downstream side in the conveying direction of a guide range with which the leading end of each of the planographic printing plates 111 conveyed-out from the storage shelf 144, to an intermediate roller 158 close to an outlet of the conveying path set in a lower side of the main conveying belt 148, in the main conveying belt 148.

In the main conveying belt winding mechanism 150 structured as mentioned above, the leading end of the planographic printing plate 111 which is only one separated by the conveying-out roller 146 so as to be conveyed-out comes into contact with a guide range 148A corresponding to the portion provided in the tensional manner between the first roller 151 in the leading end of the main conveying belt 148 and the intermediate roller 156, and is conveyed to the intermediate roller 156 side in accordance with the traveling motion of the main conveying belt 148.

In this sheet feeder 112, the leading end of the planographic printing plate 111 conveyed-out by the conveying-out roller 146 comes into contact with the main conveying belt 148 tensioned to the guide range 148A, the main conveying belt 148 is easily deformed elastically so as to receive the planographic printing plate 111 in such a manner as not to apply an impact, the main conveying belt 148 in the portion with which the leading end of the planographic printing plate 111 comes into contact is deformed in an approximately C-shaped form, and the planographic printing plate 111 is deflected in such a manner that leading end portion may be smoothly pinched between the main conveying belt 148 and the auxiliary conveying belt 152 at the position of the intermediate roller 156. As mentioned above, since the planographic printing plate 111 is elastically and softly received at a time when the leading end comes into contact with the main conveying belt 148, it is possible to prevent an external injury from being formed on the photosensitive layer forming the photosensitive layer 10A.

Further, in this sheet feeder 112, whatever turns of the planographic printing plate 111 is conveyed-out from the bundle of the planographic printing plates 111, the leading end of the planographic printing plate 111 pulled up on the basis of the roller contact of the conveying-out roller 146 always comes into contact with the main conveying belt 148 within the guide range 148A so as to be capable of suitably conveying out.

Therefore, in accordance with this sheet feeder 112, even if the pulling out position is changed each time when the planographic printing plate 111 is pulled out from the bundle of the planographic printing plates 111, it is possible to feed out the planographic printing plate 111. Accordingly, since it is not necessary to provide any complicated apparatus for regulating the pulling out position of the planographic printing plate 111 in the storage shelf 144, it is possible to simplify the structure, and it is possible to downsize the apparatus.

Further, the planographic printing plate 111 in which the leading end is guided by the main conveying belt 148 is conveyed on the conveying path in the state of being pinched and held between the main conveying belt 148 and the auxiliary conveying belt 152, at the position of the intermediate roller 156, and the pinched state is released at the position of the intermediate roller 158 near the outlet, whereby the planographic printing plate 111 is conveyed in the inner drum exposure apparatus 114.

The inner drum exposure apparatus 114 in the CTP system is structured on the basis of the support body 134 having a circular arc inner peripheral surface shape (the shape constituting a part of a cylindrical inner peripheral surface), and is structured such as to support the planographic printing plate 111 along the inner peripheral surface of the support body 134.

In this inner drum exposure apparatus 114, the exposure process is executed after securely holding the planographic printing plate 111 corresponding to the unrecorded recording medium in a state of being close attached to the inner peripheral surface of the support body 134 so as to be along, by a vacuum suction unit (not shown).

In this inner drum exposure apparatus 114, a spinner mirror apparatus 136 serving as a light beam deflecting device is arranged at a center position of a circular arc of the support body 134. The spinner mirror apparatus 136 is structured such as to be capable of rotating a rotating shaft 140 arranging a reflection mirror member (a spinner mirror) 138 on a top surface at a high speed by a motor serving as a driving source rotationally controlled by a spinner driver of the control apparatus (not shown). In this spinner mirror apparatus 136, a center axis of rotation of the rotating shaft 140 is structured such as to coincide with a center axis of the circular arc of the support body 134.

In this spinner mirror apparatus 136, a scanning exposure in a main scanning direction is executed with respect to the photosensitive surface of the planographic printing plate 111 by reflecting the light beam projected from the optical system in the light source side on a reflection mirror surface of the rotating reflection mirror member 138.

The spinner mirror apparatus 136 is controlled so as to be moved at a uniform speed in an axial direction (a direction penetrating from the front surface to the back surface in FIG. 2) of the center axis of the circular arc of the support body 134 by an auxiliary scanning and moving unit (not shown), thereby scanning in an auxiliary manner.

Accordingly, in the spinner mirror apparatus 136, the rotation of the motor is controlled by the spinner driver of the control apparatus, and the spinner mirror apparatus 136 is controlled so as to be moved in the auxiliary scanning direction by the auxiliary scanning and moving unit (not shown).

The spinner mirror apparatus 136 structured as mentioned above executes a process of recording a two-dimensional image on a whole surface of the recording surface of the planographic printing plate 111, by moving the spinner mirror apparatus 136 in the auxiliary scanning direction while executing the scanning exposure in the main scanning direction by reflecting the light beam projected from the optical system in the light source side and modulated in correspondence to the image information on the reflection mirror surface of the rotating reflection mirror member 138.

The buffer apparatus 116 in this CTP system has a function of conveying the planographic printing plate 111 exposed by the inner drum exposure apparatus 114 into the developing process apparatus 118 at a desired timing by regulating a conveying speed.

The developing process apparatus 118 changes the latent image to the visual image by executing the developing process with respect to the conveyed-out and exposed planographic printing plate 111 so as to manufacture the printing plate.

In this case, in addition to the photopolymer PS plate in which the protection of the interleaving sheet is not necessary as mentioned above, the automatic feeder of the planographic printing plate may utilize, for example, a so-called thermal PS plate, that is, a material in which an overcoat layer (an OC layer constructed by a water soluble material which may be completely removed in the washing step before the development) is applied onto an outermost front surface of the recording layer, for preventing the scratch from being formed on the recording layer forming the image formed on the front surface. Further, the automatic feeder of the planographic printing plate may utilize a surface-reinforced type thermal PS plate in which the protection of the interleaving sheet is not necessary, and the front surface in the recording layer side is reinforced in such a level that the scratch does not come into question even by being handled in the directly layered and bundled state.

Further, it goes without saying that the structure of the automatic feeder of the planographic printing plate may be utilized for separating and feeding a (optical mode) planographic printing plate recording the image on the recording layer by utilizing the light, a (thermal mode) planographic printing plate recording the image on the recording layer by utilizing a heat, a (optical and thermal mode) planographic printing plate recording the image by converting the light into the heat in the recording layer, a planographic printing plate utilizing a chemical reaction, and a planographic printing plate utilizing a physical phenomenon, corresponding to a planographic printing plate in correspondence to a plate making system generally used in the field of the lithographic printing, one by one.

Further, in the automatic feeder of the planographic printing plate, the description is given of the structure in which the storage shelf 144 of the sheet feeder 112 is arranged diagonally at the predetermined angle θ, however, the storage shelf mounting the bundle of the planographic printing plates 114 may be structured such as to be arranged in a horizontal direction.

### DESCRIPTION OF REFERENCE NUMERALS

110 automatic feeder
111 planographic printing plate
112 sheet feeder
146 convey-out roller
200 pickup unit
202 sucker
202A skirt portion
250 sliding friction reducing member

1. An automatic planographic printing plate feeder comprising:
a storage shelf, mounting a bundle of a predetermined plurality of planographic printing plates, the bundle being formed by stacking the back surface side of a planographic printing plate on a recording surface side that is on the front surface of another planographic printing plate;
a conveying unit, conveying out the uppermost planographic printing plate of the bundle of planographic printing plates by applying a force in a conveying direction while pressing the uppermost planographic printing plate;
a sliding friction reducing member, interposed in a region in which the pressing load of the conveying unit presses the planographic printing plate below the uppermost planographic printing plate through the uppermost planographic printing plate; and
a separating operation unit for inserting the sliding friction reducing member by forming a gap between the uppermost planographic printing plate of the bundle of planographic printing plates mounted on the storage shelf and the planographic printing plate therebelow.

2. An automatic planographic printing plate feeder of claim 1, wherein the sliding friction reducing member is formed by an elastic sheet material.

3. An automatic planographic printing plate feeder of claim 1, wherein a friction coefficient μ1 between the front surface of the sliding friction reducing member and the back surface of the uppermost first planographic printing plate is set smaller than a friction coefficient μ2 between the back surface of the sliding friction reducing member and the front surface of the recording surface side of a second planographic printing plate positioned below the first planographic printing plate.

4. An automatic planographic printing plate feeder of claim 2, wherein a friction coefficient μ1 between the front surface of the sliding friction reducing member and the back surface of the uppermost first planographic printing plate is set smaller than a friction coefficient μ2 between the back surface of the sliding friction reducing member and the front surface of the recording surface side of a second planographic printing plate positioned below the first planographic printing plate.

5. An automatic planographic printing plate feeder of claim 1, wherein the separating operation unit serves as a handling unit that puts air between the uppermost planographic printing plate and the planographic printing plate therebelow by lifting and then releasing the uppermost planographic printing plate of the bundle of planographic printing plates mounted in the storage shelf.

6. An automatic planographic printing plate feeder of claim 2, wherein the separating operation unit serves as a handling unit that puts air between the uppermost planographic printing plate and the planographic printing plate therebelow by lifting and then releasing the uppermost planographic printing plate of the bundle of planographic printing plates mounted in the storage shelf.

7. An automatic planographic printing plate feeder of claim 3, wherein the separating operation unit serves as a handling unit that puts air between the uppermost planographic printing plate and the planographic printing plate therebelow by lifting and then releasing the uppermost planographic printing plate of the bundle of planographic printing plates mounted in the storage shelf.

8. An automatic planographic printing plate feeder comprising:
a storage shelf, mounting a bundle of a predetermined plurality of planographic printing plates, the bundle being formed by stacking the back surface side of a planographic printing plate on a recording surface side on the front surface of another planographic printing plate;
a conveying unit, conveying out the uppermost planographic printing plate of the bundle of the planographic printing plates by applying a force in a conveying direction while pressing the uppermost planographic printing plate;
a sliding friction reducing member, interposed in a region in which the pressing load of the conveying unit presses the planographic printing plate below the uppermost planographic printing plate through the uppermost planographic printing plate; and
a separating operation unit for inserting the sliding friction reducing member by forming a gap between the uppermost planographic printing plate of the bundle of planographic printing plates mounted on the storage shelf and the planographic printing plate therebelow, wherein
the sliding friction reducing member is formed by an elastic sheet material, a friction coefficient μ1 between the front surface of the sliding friction reducing member and the back surface of the uppermost first planographic printing plate positioned is set smaller than a friction coefficient μ2 between the back surface of the sliding friction reducing member and the front surface of the recording surface side of a second planographic printing plate positioned below the first planographic printing plate, and the separating operation unit serves as a handling unit putting air between the uppermost planographic printing plate and the planographic printing plate therebelow, by lifting and then releasing the uppermost planographic printing plate in the bundle of planographic printing plates mounted in the storage shelf.
